(19) United States
(12) Patent Application Publication
(10) Pub. No.: US 2008/0182513 A1
(43) Pub. Date: Jul. 31, 2008

(54) High Frequency Communications

(76) Inventors: Amer A. Hassan, Kirkland, WA (US); David Jones, Seattle, WA (US); Thomas W. Kuehnel, Seattle, WA (US); Taroon Mandhana, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(21) Appl. No.: 11/668,281

(22) Filed: Jan. 29, 2007

(51) Int. Cl. H04B 7/00

(52) U.S. Cl. 455/41.2

(57) ABSTRACT

If the first device has capability to communicate in the 60 GHz range, the first device may use a 60 GHz transceiver to communicate through the first antenna a request to communicate with the second device. At the first antenna of the first device, a notification may be received from the second antenna on the second device whether the second device has granted the first device permission to communicate with the first device; and if the first device receives permission to communicate with the second device, the first device may communicate with the second device.

### BACKGROUND

This Background is intended to provide the basic context of this patent application. Communication among computing devices has been necessary since the development of computing device. As the complexity of devices has increased, so has the complexity of communication. Various wired systems have been designed to aide the communication of data at high rates of speed at a high rate of reliability. In addition, wireless solutions have been developed, which under ideal conditions, can produce communication of data at high rates of speed at high rates of reliability. However, wireless solutions have limitations. While it is nice to have the broad coverage of the wireless network, such wide coverage is disadvantageous in there is a wide range of people that may be in the broad coverage that may be able to lurk and listen on communications that are meant to be private. In addition, the wireless frequencies currently in use require antennas that are relatively large, thereby limiting the size of devices that can use the wireless capabilities. Moreover, the available frequency is often either regulated meaning a license must be obtained to use it or the frequency is quite crowded which can lead to unwanted interference.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Wireless communication using the 60 GHz range has advantages in that the signal does not travel over an overly broad area, does not travel through impediments such as walls and requires transmission in an environment with a relatively clear line of sight. As such, the 60 GHz communications may be difficult to intercept but may still operate at high bandwidth.

In operation, a method may determine whether a first device has capability to communicate in the 60 GHz range. If the first device has capability to communicate in the 60 GHz range, a 60 GHz transceiver in the first device may be used to communicate through the first antenna a request to communicate with the second device. At the first antenna of the first device, a notification may be received from the second antenna on the second device whether the second device has granted the first device permission to communicate with the first device; and if the first device receives permission to communicate with the second device, the first device may communicate with the second device.

### BRIEF DESCRIPTION OF THE DRAWINGS

FIG. 1 is an illustration of hardware for a device;

FIG. 2 is a flow chart of a method of communicating using the 60 GHz range; and

FIG. 3 is an illustration of the hardware in a first device and a second device.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

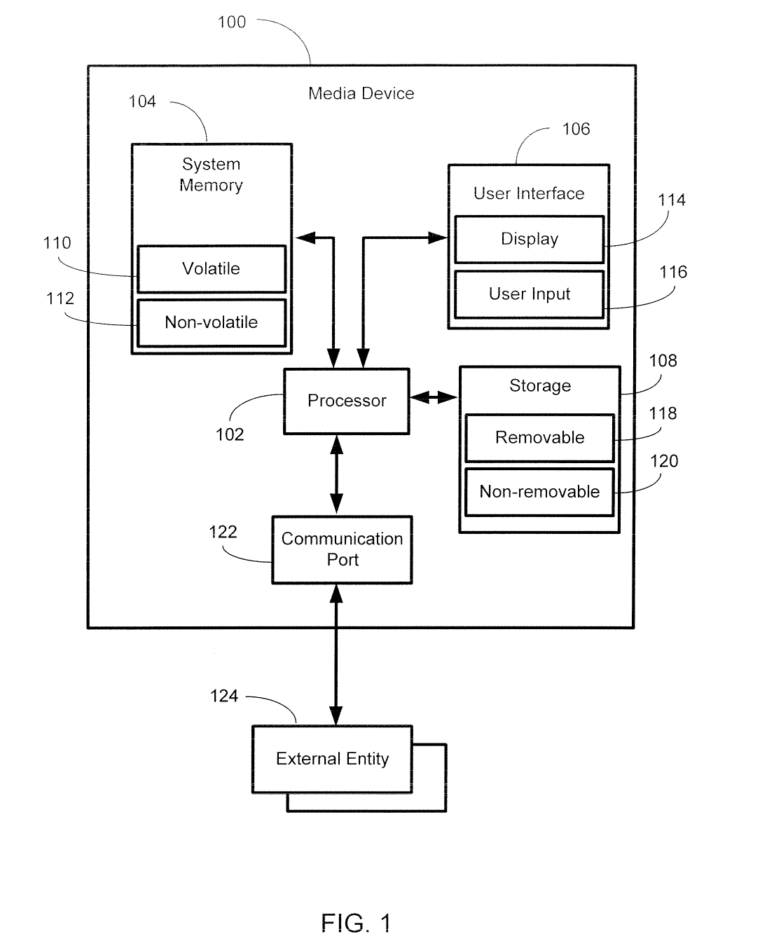

FIG. 1 is an illustration of exemplary hardware that may be used for a device 100 that may wish to communicate using the 60 GHz range. The device 100 may have a processing unit 102, a memory 104, a user interface 106, a storage device 108 and a power source (not shown). The memory 104 may include volatile memory 110 (such as RAM), non-volatile memory 112 (such as ROM, flash memory, etc.) or some combination of the two or any other form of storage device. The device 100 may also include additional storage 108 (removable and/or non-removable) including, but not limited to, magnetic or optical disks or tape or any other memory. Such additional storage is illustrated in FIG. 1 by removable storage 118 and non-removable storage 120. Computer storage media includes volatile and nonvolatile, removable and non-removable media implemented in any method or technology for storage of information such as computer readable instructions, data structures, program modules, digital media, or other data.

The processing unit 102 may be any processing unit 102 capable of executing computer code. When in a portable device, it may also be useful if the processor 102 is efficient in using power to increase the life of the power source. The processing unit 102 may also be used to execute code to support a user interface and external communications.

The user interface may include one or more displays 114 for both displaying control information and displaying viewable media. The display 114 may be a color LCD screen that fits inside the device 100. User input(s) 116 may include manual buttons, soft buttons, or a combination of both. In addition, the user input may be gesture driven which may use no buttons or may be voice activated. Soft buttons may be used when the display 114 includes a touch screen capability. Manual buttons may include re-definable keys with programmable legends. In operation, a user may use the user interface to select an application.

The media 100 may also contain communications connection(s) 122 that allow the device 100 to communicate with external entities 124, such as network endpoints or a computer used for synchronization. Communications connection(s) 122 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The power source may be a battery that may be rechargeable. The power source may also be a standard battery or an input from a power converter or any other source of power.

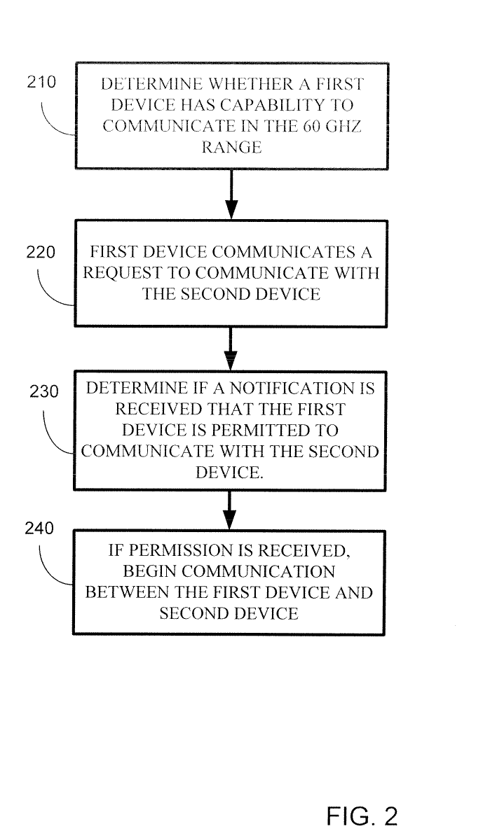

FIG. 2 illustrates a method of communicating between a first device and a second device using a signal in the 60 GHz range. The 57-64 GHz band is located in the millimeter-wave portion of the electromagnetic spectrum, where the wavelength varies from ten millimeters (30 GHz) down to one millimeter (300 GHz). The millimeter-wave portion of the RF spectrum has been largely unexploited for commercial wireless applications.

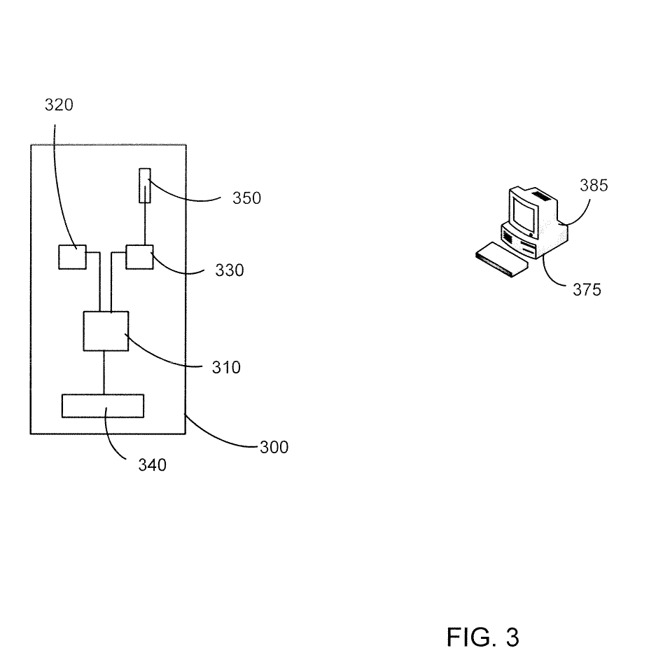

The first and second device may be a form of the device described in FIG. 1 and can support communication in the 60 GHz range. For example, FIG. 3 may be an illustration of a sample first device 300 and a second device 375. The first device 300 may have a processor 310, a memory 320, an input-output circuit 330, a power source 340 and an antenna 350 capable of communicating in the 60 GHz range. The second device 375 may have the same basic components. As the actual size of the devices 300, 375 may be quite small, the embodiments of the first 300 and second devices 375 are limited only by imagination.

The unique properties of the 60 GHz communication range make it especially useful for a variety of embodiments of the first 300 and second devices 375. Due to the frequency of the 60 GHz signal and the relative “shortness” of the signal, the size of an antenna 350 is quite small. For example, the first antenna 350 and the second antenna 385 may be less than 1 centimeter in length, allowing the antennas 350 to be placed in devices that traditionally have been thought of as too small to have communication capabilities. Related, the amplification circuits (not shown) may also be extremely small, such as on the order of 60 micrometers.

The 60 GHz range has other properties that make it especially appropriate to be adapted to a variety of situations. For example, the 60 GHz signal suffers from attenuation meaning it is degrades quickly as it travels. For example, the useful distance of the 60 GHz signal may be limited to 10 meters. However, attenuation also may be advantageous in that the signal will not travel far, meaning the signal is especially difficult to intercept. In addition, there may be several devices in a property such as an office building that use the 60 GHz range and the several devices may not interfere with each other as the signals will not travel far enough to interfere with each other.

One advantage of the 60 GHz signal is that it needs to have a virtually clear, impediment free line of site between a transmitter and a receiver such as the first device 300 and the second device 375. For example, a 60 GHz signal does not travel through walls well, if at all. Trying to receive a reliable 60 GHz signal through a wall is extremely difficult. The inability to travel through impediments such as walls also may be used as an advantage such as attenuation. As the 60 GHz signal will not travel outside of the walls of an office, intercepting the signal is difficult. In addition, several installations of the 60 GHz signal may co-exist in the same property such as an office building in that the signal will not travel outside the walls of an office building and interference among the numerous installations may be minimal.

The 60 GHz signal has the property of having high gain. In other words, the 60 GHz signal is very directional. The directional property also may be advantageous and disadvantageous. On the positive side, the directional property makes the signal hard to intercept as the interceptor must be in the general line of the orientation of the antennas 350, 385. On the negative side, care must be taken to ensure that the first device 300 is pointed at the second device 375, or, more specifically, that the antenna for the first device 350 is pointed at the antenna 385 for the second device 375 and vice versa. In one embodiment, the first antenna 350 and second antenna 385 have a length longer than a width and that pointing the antenna 350, 385 entails orienting the first device 300 such that the length of the first antenna 350 is oriented toward the length of the second antenna 385.

The 60 GHz range has the advantage of allowing communication at very high bandwidth. As the 60 GHz signal is at such a high frequency, it can communicate at a very high bandwidth such as a gigabit per second or higher.

The 60 GHz range also has the advantage of being open to the public in most countries. As a result, a license is not needed to communicate in this range. As such, complexity of installation is reduced and the potential interference is also reduced.

As a result of the unique properties of the 60 GHz range, it may be useful to communicate in small spaces at a very high bandwidth with minimal fear of having the signal intercepted or interfere with other users of the 60 GHz range. There are many situations where such communication would be useful where currently, wired connections are used. In addition, wifi (802.11 type signals) and WiMax may also be used, but these signals do not attenuate as quickly as a 60 GHz signal, leaving them more open to interception. Somewhat related, infrared signals may have the desired characteristic of being difficult to intercept, but the bandwidth of the infrared signal is significantly less that that of the 60 GHz range.

Referring again to FIG. 2, at block 210, it may be determined whether a first device 300 has capability to communicate in the 60 GHz range. In one embodiment, a discovery protocol is used to determine if the first device 300 has the capability to communicate in the 60 GHz range. In some embodiments, the discovery protocol may be part of an operating system, while in other embodiments, the protocol is part of a stand alone application designed specifically for this purpose. As such, the determination may occur in a variety of devices, from a small dedicated device such as a memory pen to a PC. Again, the protocol may be of virtually any format, from simply checking for a flag to be set to a complex secure procedure of exchanging public and private keys to verify capabilities.

An operating system (OS) may be a computer program that manages the hardware and software resources of a computer or processor. The OS performs basic tasks such as controlling and allocating memory, prioritizing system requests, controlling input and output devices, facilitating networking, and managing files. A sample computer operating system may be Windows® from Microsoft Corporation and operating systems may have more or less features, depending on the device and implementation.

The actual circuitry to send and receive in the 60 GHz range is available from a variety of sources. One such source is SiBeam Corporation of Sunnyvale, Calif. (www.sibeam.com). In other embodiments, a circuit may be specifically designed for a particular 60 GHz use. The 60 GHz communication may use a separate transmitter and receiver or may use a transceiver. The transmitter, receiver or transceiver may be part of the input-output circuit 330. Of course, other sources and designs may be available and are possible.

If at block 210 it is determined that the first device 300 has the capability to communicate in the 60 GHz range, a type of authorization may occur. For example, at block 220, a 60 GHz transceiver in the first device 300 may be used to communicate through the first antenna, a request to communicate with the second device. The actual request may take on a virtually limitless number of embodiments. In some embodiments, the request follows a very rigid format such that it can be quickly parsed and understood, while in other embodiments, the request is more fluid. Of course, the request has to be understood, but the devices may also be able follow previously existing or future generated communication protocols to make such communications occur.

The request may be made in a variety of ways. In one embodiment, a dedicated button on a device starts communication in the 60 GHz range from the first device 300 to the second device 375. In other embodiment, a selection is made on a user interface on a piece of software. Other implementations are possible.

If the second device 375 receives part of the message, but part is not understood, such as it is lost in communication, an error message may be returned to the first device 300. In this case, based on the error message, the first device 300 may adjust all or part of the transmission and attempt the communication once again. For example, the first device 300 may ensure there is a clear line of sight to the second device 375 or the first device 300 may be moved closer to the second device 300. Other adjustments are possible.

At block 230, a notification may be received at the first antenna 350 of the first device 300 from the second antenna 385 on the second device 375 whether the second device 375 has granted the first device 300 permission to communicate with the second device 375. From the perspective of the second devices 375, if a communication from the first device 300 is received at the second device 375, a notification may be created on the second device 375 that the first device 300 is attempting to communicate with the second device 375. This notification may take a variety of embodiments. In one embodiment, the notification is a pop-up window. In another embodiment, the notification is an icon that may be displayed near other network related icons. In yet another embodiment, the notification is a noise. Of course, the type of notification may only be limited by the imagination and the capabilities of the various devices.

In response to receiving the notification on the second devices 375, a plurality of options may be displayed on the second device 375. For example, a user on the second device 375 may be permitted to permanently block communication from the first device 300, block communication temporarily for the first device 300, grant permanent access for the first device 300 or grant temporary access for the first device 300. The permission or denial of permission along with the type of permission may be communicated to the first device 300. Of course, other options are possible, such as delaying the access or allowing access for a limited purpose or type of file.

Identifiers may be stored for devices that have attempted to communicate with the second device 375 (or with the first device 300). Upon a selection, a list of the devices may be displayed that have communicated with the second device 375 and the permission that was granted to the devices. In one embodiment, the permissions granted to the devices may be adjusted.

If access was granted for the first device 300 to communicate with the second device 375, it also may be determined whether the first device 300 should be permitted to synchronize with the second device 375. If the first device 300 is an electronic calendar device and the second device 375 is a personal computer with a calendar program such as Microsoft Outlook®, it may be useful to synchronize the two devices 300, 375 and it may be useful to have this synchronization occur automatically. For example, if permanent access for the first device 300 (a PDA) has been granted and if permission has been granted for the first device 300 to synchronize with the second devices 375 (a PC that operated Microsoft Outlook®), the first device 300 and second device 375 may be automatically synchronized when communication is initiated between the first device 300 and second device 375.

Other actions may also occur instead of synchronization. For example, the first device 300 may be a laptop and the second device 375 may be a docking station. The second device 375 may recognize a communication from the laptop and may determine that permanent permission has been previously granted to this specific laptop. As a result, the first device 300 may automatically be docked to the second device 375 (docking station) using 60 GHz communication rather than a physical link. Other embodiments are possible.

At block 240, communication may commence between the first device 300 and second device 375 if the first device 300 receives permission to communicate with the second device 375. If permission is not received, a notification may occur on the first device 300 that permission to communicate with the second device 375 was denied. In response, the first device 300 may stop attempting to communicate with the second device 375.

During communication, encryption may be used to further secure the signal from being intercepted and understood. The encryption may be automatic, such as part of an operating system like Microsoft Windows®, or may be selected by the user.

If a response is not received from the second device 375 for a time-out period, a message may be displayed on the first device 300 that communication cannot be established with the second device 375. An additional message may be displayed to ensure that the antenna 350 for the first device 300 is oriented toward a second antenna 385 for the second device 375 or to ensure that the first device 300 and second device 375 have an unobstructed view of each other or to ensure that the first device 300 and second device 375 are close enough to each other. Of course, the type and form of the notification may be varied.

If permission is received at the first device 300 from the second device 375, communication between the devices 300, 375 may continue until a termination event occurs. Sample termination events include the expiration of a time out period when no communication occurs, a specific selection on one of the devices 300, 375 is made to end communication, an excessive number of errors occurs during communication, etc. Certainly, the termination event may take a variety of forms.

Examples of possible uses of an application in accordance with the claims are many. Just about any situation where communication occurs over a distance of approximately 20 meters or less would lend themselves to using 60 GHz communication. As one example, a writing instrument such as a pen may be considered a first device 300. It may have a processor, a memory, an input output circuit, a power source (a battery) and an antenna. Data may be stored in the memory and may be communicated to a second device 375 using the antenna. As an added advantage, the communication may be at a very high bandwidth and may be secure in that the communication is difficult to intercept.

Another possible implementations has a personal computer broken into several components and the components communication using the 60 GHz range. For example, a keyboard may communicate to a separate processor using the 60 GHz range, the processor may communicate to a bulk storage device, a display and a printer using the 60 GHz range. Other possible embodiments, include, but are not limited to:

processor to projector;

laptop to network;

handheld to laptop;

media player to cpu or network;

cell phone to cpu or network;

camera to cpu;

dvd player to cpu; and

television storage device to television.

In addition, the implementation may be interoperable with other communication devices and protocols. For example, a 60 GHz signal may be received and repeated using a different frequency or even using wired communication and then transferred back to a 60 GHz signal. For example, a cell phone that has music playing capability may be able to make a telephone call to sync the music on the cell phone with the music on a remote hard drive at a user's home. The call may be answered by an answering device that communicates in the 60 GHz spectrum to the remote hard drive to obtain the needed sync data which is then communicated over the cellular system to the cell phone. As part of an application or operating system, the 60 GHz signal may be transformed into a signal useful by the cellular system. Of course, other implementations and transformations are possible.

In another embodiment, a user may decide which communication frequency to use based on the situation. For example, if a user is out of direct sight of a 60 GHz communication transceiver, the user may use another communication frequency such as an 802.11 type frequency. This determination may occur automatically or may be may by an operating system that reviews the sensitivity of the data being communicated and selects a communication method that is appropriate based on the sensitivity of the data. For example, communication with a web site of a bank may be assumed to use extremely sensitive data, making communication in the 60 GHz range more desirable than communication in the 802.11 range.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

1. A method of communicating between a first device and a second device using a signal in the 60 GHz range comprising:
Determining whether a first device has capability to communicate in the 60 GHz range;
if the first device has capability to communicate in the 60 GHz range:
using a 60 GHz transceiver in the first device to communicate through the first antenna a request to communicate with the second device;
receiving at the first antenna of the first device a notification from the second antenna on the second device whether the second device has granted the first device permission to communicate with the first device; and
if the first device receives permission to communicate with the second device, communicating with the second device.

2. The method of claim 1, further comprising ensuring that a first antenna for the first device is oriented toward a second antenna for the second device where the first device and second device have an unobstructed view of each other.

3. The method of claim 1, further comprising if communication cannot be established with the second device, displaying a message on the first device that communication cannot be established with the second device.

4. The method of claim 3, further comprising displaying a message to ensure that the antenna for the first device is oriented toward a second antenna for the second device and to ensure that the first device and second device have an unobstructed view of each other.

5. The method of claim 1, further comprising if the first device does not receive permission to communicate with the second device, ending communication with the second device.

6. The method of claim 2, wherein the first antenna and second antenna have a length longer than a width and that pointing the antenna comprises orienting the first device such that the length of the first antenna is oriented toward the length of the second antenna.

7. The method of claim 1, further comprising if a communication from the first device is received at the second device, creating a notification on the second device that the first device is attempting to communicate with the second device.

8. The method of claim 7, further comprising if a notification is created on the second device that the first device is attempting to communicate with the second device, displaying a plurality of options selected from a group comprising:
a. Block communication permanently;
b. Block communication temporarily;
c. Grant permanent access for the first device; and
d. Grant temporary access for the first device.

9. The method of claim 8, further comprising if access is granted for the first device to communicate with the second device, determining whether the first device should be permitted to synchronize with the second device.

10. The method of claim 9, wherein if permanent access for the first device has been granted and if permission has been granted for the first device to synchronize with the second device, automatically synchronizing the first and second device when communication is initiated between the first and second device.

11. The method of claim 10, further comprising storing identifiers for devices that have communicated with the second device and upon a selection, displaying a list of the devices that have communicated with the second device and the permission that was granted to the devices.

12. The method of claim 11, further comprising allowing adjustment to the permissions granted to the devices.

13. The method of claim 1, wherein the 60 GHz signal is attenuated when transmitted through walls such that the entire communication cannot be understood.

14. The method of claim 1, wherein a bandwidth of the communication is at least 100 megabits per second.

15. The method of claim 1, wherein the first antenna and second antenna are less than 1 centimeter in length.

16. The method of claim 1, wherein using an operating system to determine whether a first device has capability to communicate is the 60 GHz range further comprises using a discovery protocol to make the determination.

17. A computer storage medium for storing computer executable instructions, the computer storage medium comprising computer executable instruction for:
Determining whether a first device has capability to communicate in the 60 GHz range;
if the first device has capability to communicate in the 60 GHz range:
using a 60 GHz transceiver in the first device to communicate through the first antenna a request to communicate with the second device;
if communication cannot be established with the second device, displaying a message on the first device that communication cannot be established with the second device;
if communication from the first device is received at the second device, creating a notification on the second device that the first device is attempting to communicate with the second device;
receiving at the first antenna of the first device a notification from the second antenna on the second device whether the second device has granted the first device permission to communicate with the first device; and
if the first device receives permission to communicate with the second device, communicating with the second device.

18. The computer executable instructions of claim 17, further comprising if a notification is created on the second device that the first device is attempting to communicate with the second device, computer executable instructions for displaying a plurality of options selected form a group comprising:
a. Block communication permanently;
b. Block communication temporarily;
c. Grant permanent access for the first device; and
d. Grant temporary access for the first device.

19. The computer executable instructions of claim 17, further comprising storing identifiers for devices that have communicated with the second device and upon a selection, displaying a list of the devices that have communicated with the second device and the permission that was granted to the devices and allowing adjustment to the permissions granted to the devices.

20. A computing device comprising a processor for executing computer executable code, a memory for storing computer executable code, an input output device, the computer executable code comprising instructions for:
Determining whether a first device has capability to communicate in the 60 GHz range;
if the first device has capability to communicate in the 60 GHz range:
Using a 60 GHz transceiver in the first device to communicate through the first antenna a request to communicate with the second device;
if communication cannot be established with the second device, displaying a message on the first device that communication cannot be established with the second device;
if a communication from the first device is received at the second device, creating a notification on the second device that the first device is attempting to communicate with the second device wherein the options are selected from a group comprising:
a. Block communication permanently;
b. Block communication temporarily;
c. Grant permanent access for the first device; and
d. Grant temporary access for the first device
storing identifiers for devices that have communicated with the second device and upon a selection, displaying a list of the devices that have communicated with the second device and the permission that was granted to the devices and allowing adjustment to the permissions granted to the devices;
receiving at the first antenna of the first device a notification from the second antenna on the second device whether the second device has granted the first device permission to communicate with the first device; and
if the first device receives permission to communicate with the second device, communicating with the second device.
